(19) United States
(12) Patent Application Publication
(10) Pub. No.: US 2012/0045625 A1
(43) Pub. Date: Feb. 23, 2012

(54) METHOD OF MANUFACTURING LAMINATE, METHOD OF MANUFACTURING RETARDATION FILM, AND THE RETARDATION FILM

(75) Inventors: Taro Omura, Miyagi (JP); Mitsunari Hoshi, Miyagi (JP); Michio Sato, Tochigi (JP)

(73) Assignee: SONY CORPORATION, Tokyo (JP)

(21) Appl. No.: 13/187,710

(22) Filed: Jul. 21, 2011

(30) Foreign Application Priority Data
Jul. 28, 2010 (JP) P2010-169555

(51) Int. Cl. B32B 3/00; B32B 37/00

(52) U.S. Cl. 428/195.1; 156/64

(57) ABSTRACT

A method of manufacturing a laminate includes: a step of deriving, by the processor, an in-plane positional relationship between the retardation film and the object from an image of each of the retardation film and the object captured by the camera while the retardation film and the object are disposed in this order from a side of the camera within the imaging area of the camera at positions on a side opposite to the camera with respect to the (2n+1)λ/4 retardation film; and a step of performing alignment of the retardation film to the object based on the positional relationship derived by the processor, and then attaching the retardation film to the object.

### CROSS REFERENCES TO RELATED APPLICATIONS

The present application claims priority to Japanese Priority Patent Application JP 2010-169555 filed in the Japan Patent Office on Jul. 28, 2010, the entire content of which is hereby incorporated by reference.

### BACKGROUND

The present application relates to a method of manufacturing a laminate with high alignment accuracy, and to a method of manufacturing a retardation film. In addition, the disclosure relates to a retardation film allowing improvement in alignment accuracy.

Recently, a display capable of three-dimensional display has been increasingly developed. A three-dimensional display method includes, for example, a method where a right-eye image and a left-eye image are displayed on a display screen, and the images are viewed by a viewer wearing polarized glasses (for example, see Japanese Unexamined Patent Application Publication No. 2000-221461). The method is achieved by disposing a patterned retardation film on a front surface of a display capable of two-dimensional display, for example, a cathode-ray tube, a liquid crystal display, or a plasma display. The retardation film is patterned to have retardation or an optical axis at a display pixel level in order to control a polarization state of light incident to respective two eyes. It is therefore necessary to attach the retardation film to a display in correspondence to pixels of the display.

When the retardation film is attached to a display panel or to a black stripe film, accurate alignment is necessary. Moreover, when the retardation film is manufactured of a roll base, the roll base needs to be accurately aligned to a punching machine. In the former case, for example, it is therefore conceivable that both the retardation film and the film are put with alignment marks, an image of each alignment mark be captured by a detection camera, and a relative positional relationship between the both be derived from the image. In the latter case, for example, it is conceivable that the roll base is put with an alignment mark, a plurality of detection cameras be fixed to the punching machine, an image of the alignment mark on the roll base be captured by a detection camera, and a relative positional relationship between the base and the punching machine be derived from the image.

### SUMMARY

A method of forming the alignment mark on an object conceivably includes, for example, a method where an alignment mark is added on a produced object by evaporation or printing, or a method where an object is produced using a marked member. However, when such a method is used for attaching the retardation film to the display panel, a retardation region of the retardation film is formed in a separate step from formation of the alignment mark. It is therefore necessary to perform accurate positioning of one while recognizing a position of the other in order to improve alignment accuracy. This disadvantageously results in a complicated manufacturing process or increase in number of steps.

Thus, for example, both a patterned retardation region and an alignment mark region of a retardation film are conceivably collectively formed by transfer using a metal master having an irregular pattern so that the patterned retardation region and the alignment mark region of the retardation film are formed in one step. In such a case, alignment accuracy may be improved with a simple method and in a small number of steps. However, in such a case, a λ/4 retardation film and a polarizing plate need to be provided between a detection camera and the alignment mark region for image recognition of the alignment mark region.

However, for example, when the retardation film is attached to the display panel, a protective film is beforehand attached to a surface of the retardation film to protect the surface from being damaged or stained. Similarly, when the retardation film is attached to a black stripe film, a protective film is beforehand attached to a surface of the retardation film. In addition, when the retardation film is manufactured of a roll base, a protective film is also beforehand attached to a surface of the roll base in the case of cutting the retardation film into a desired size.

A PET film having high retardation is typically used for a base of the protective film. Polarization is therefore disturbed by the protective film, and therefore the detection camera hardly captures a clear image of the alignment mark. This disadvantageously leads to reduction in accuracy of position detection of the alignment mark, resulting in reduction in alignment accuracy.

It is desirable to provide a method of manufacturing a laminate with high alignment accuracy, and a method of manufacturing a retardation film. In addition, it is desirable to provide a retardation film allowing improvement of alignment accuracy.

A method of manufacturing a laminate according to an embodiment includes the following four steps. In the following, λ denotes, for example, a wavelength in a green range of about 500 to 560 nm.

(A1) A first step of preparing equipment having one or more cameras and a processor processing an image captured by each of the cameras, and having a polarizing plate and a (2n+1)λ/4 retardation film (n is an integer of 0 or more) in this order from a camera side within an imaging area of the camera.

(A2) A second step of preparing a retardation film having a retardation layer with a patterned retardation region including two or more kinds of retardation regions different in slow-axis direction from each other and having a protective film with a retardation of (n/2−0.14)λ or more and (n/2+0.14)λ or less, and preparing an object to be attached with the retardation film.

(A3) A third step of deriving, by the processor, an in-plane positional relationship between the retardation film and the object from an image of each of the retardation film and the object captured by the camera while the retardation film and the object are disposed in this order from a camera side within an imaging area of the camera at positions on a side opposite to the camera with respect to the (2n+1)λ/4 retardation film.

(A4) A fourth step of performing alignment of the retardation film to the object based on the positional relationship derived by the processor, and then attaching the retardation film to the object.

In the method of manufacturing the laminate according to the embodiment, a film having a retardation of (n/2−0.14)λ or more and (n/2+0.14)λ or less is used as the protective film for protecting the retardation layer. This allows a sufficiently high contrast to be obtained when the retardation film and the object are imaged by the camera through the protective film.

A method of manufacturing a retardation film according to an embodiment includes the following four steps. In the following, λ denotes, for example, a wavelength in a green range of about 500 to 560 nm.

(B1) A first step of preparing equipment having a punching machine, one or more cameras fixed to the punching machine, and a processor processing an image captured by each of the cameras, and having a polarizing plate and a (2n+1)λ/4 retardation film (n is an integer of 0 or more) in this order from a camera side within an imaging area of the camera.

(B2) A second step of preparing a retardation roll sheet having a retardation layer with a patterned retardation region including two or more kinds of retardation regions different in slow-axis direction from each other and having a protective film with a retardation of (n/2−0.14)λ or more and (n/2+0.14)λ or less.

(B3) A third step of deriving, by the processor, an in-plane positional relationship between the retardation roll sheet and the punching machine from an image of the retardation roll sheet captured by the camera.

(B4) A fourth step of performing alignment of the retardation roll sheet to the punching machine based on the positional relationship derived by the processor, and then producing a retardation film by punching the retardation roll sheet by the punching machine.

In the method of manufacturing the retardation film according to the embodiment, a film having a retardation of (n/2−0.14)λ or more and (n/2+0.14)λ or less is used as the protective film for protecting the retardation layer. This allows a sufficiently high contrast to be obtained when the retardation roll sheet is imaged by the camera through the protective film.

A retardation film according to an embodiment includes a retardation layer and a protective film. The retardation layer has a patterned retardation region including two or more kinds of retardation regions different in slow-axis direction from each other. The protective film has a retardation of (n/2−0.14)λ or more and (n/2+0.14)λ or less (n is an integer of 0 or more). In the above, λ denotes, for example, a wavelength in a green range of about 500 to 560 nm.

In the retardation film according to the embodiment, a film having a retardation of (n/2−0.14)λ or more and (n/2+0.14)λ or less is used as the protective film for protecting the retardation layer. Consequently, for example, in the case of attaching the retardation film to an object such as a display panel or a black stripe film, when the retardation film and the object are imaged by the camera through the protective film, a sufficiently high contrast may be obtained. In addition, for example, in the case of punching the retardation film from a roll, when the roll is imaged by the camera through the protective film, a sufficiently high contrast may be obtained.

According to the method of manufacturing the laminate of the embodiment, when the retardation film and the object are imaged by the camera through the protective film, a sufficiently high contrast may be obtained, leading to improvement in alignment accuracy.

According to the method of manufacturing the retardation film of the embodiment, when the retardation roll sheet is imaged by the camera through the protective film, a sufficiently high contrast may be obtained, leading to improvement in alignment accuracy.

According to the retardation film of the embodiment, when the retardation film and the object are imaged by the camera through the protective film, or when the roll is imaged by the camera through the protective film, a sufficiently high contrast may be obtained, leading to improvement in alignment accuracy.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the application.

FIGS. 1A and 1B are a perspective diagram of a retardation film according to an embodiment, and a top diagram of a retardation layer in the retardation film, respectively.

FIG. 2 is a diagram illustrating an example of a sectional configuration in an A-A arrow direction of the retardation film of FIG. 1B.

FIG. 3 is a diagram illustrating another example of the retardation film of FIG. 2.

FIG. 4 is a diagram illustrating another example of the retardation film of FIG. 1B.

FIG. 5 is a diagram explaining punching of the retardation film of FIG. 1A in a manufacturing process.

FIG. 6 is a diagram explaining an example of a position detection system used in punching as shown in FIG. 5.

FIG. 7 is a diagram explaining another example of the position detection system used in punching as shown in FIG. 5.

FIGS. 8A and 8B are diagrams illustrating an example of a relationship between retardation and a contrast of a protective film.

FIG. 9 is a table illustrating an example of a relationship between various films used as the protective film and punching accuracy.

FIG. 10 is a diagram illustrating an example of a method of attaching the retardation film of FIG. 1A to a black stripe film.

FIG. 11 is a diagram illustrating an example of a position detection system used in attaching as shown in FIG. 10.

FIG. 12 is a diagram illustrating another example of the position detection system used in attaching as shown in FIG. 10.

FIG. 13 is a diagram illustrating an example of a method of attaching the retardation film of FIG. 1A to a display panel.

FIG. 14 is a diagram illustrating an example of a position detection system used in attaching as shown in FIG. 13.

FIG. 15 is a diagram illustrating another example of the position detection system used in attaching as shown in FIG. 13.

### DETAILED DESCRIPTION

Embodiments of the present application will be described below in detail with reference to the drawings.

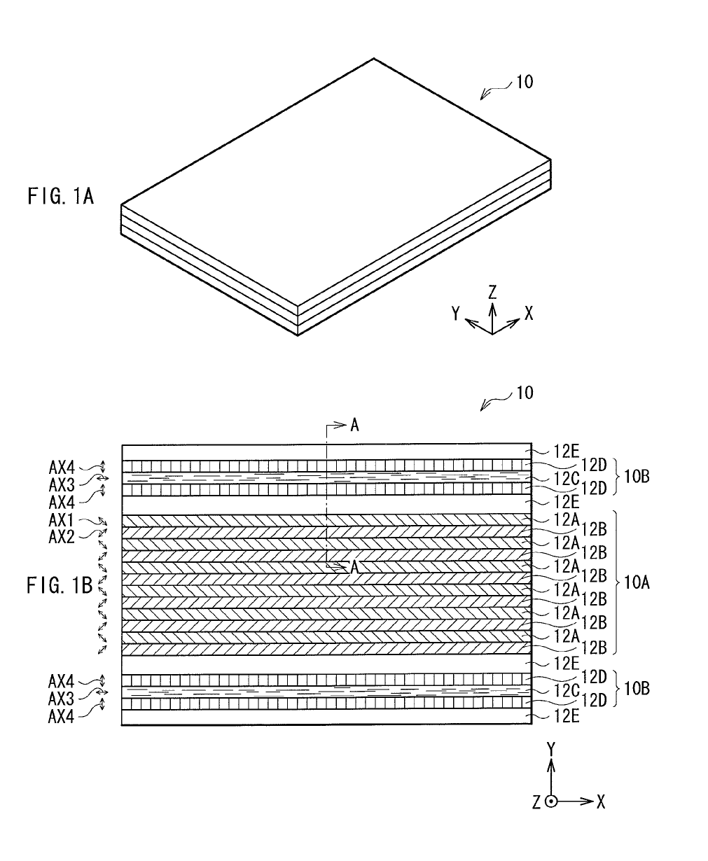

1. Embodiment (FIGS. 1 to 9)

Example of punching a retardation film from a retardation roll sheet

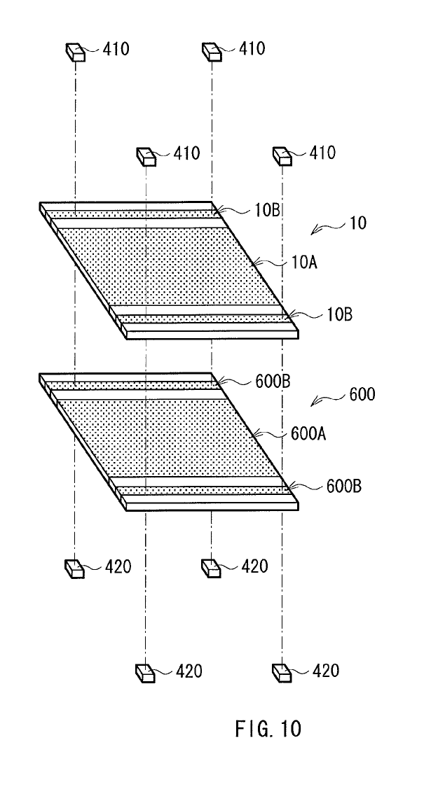

2. Application Examples (FIGS. 10 to 15)

Example of attaching a retardation film to a black stripe film

Example of attaching a retardation film to a display panel

### 1. Embodiment

Configuration of Retardation Film 10

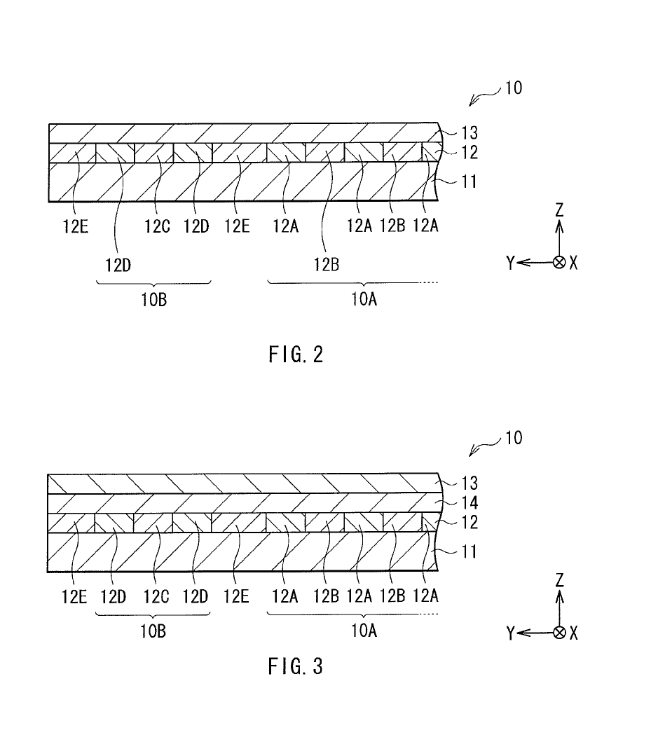

FIG. 1A schematically illustrates a retardation film 10 according to a first embodiment. FIG. 1B illustrates an example of a top configuration of a retardation layer 12 (described later) of the retardation film 10 of FIG. 1A. FIG. 2 illustrates an example of a sectional configuration in an A-A arrow direction of the retardation film 10 of FIG. 1A.

The retardation film 10 has a patterned retardation region 10A disposed in a place to be opposed to a display pixel region when the retardation film 10 is used for 3D display, and alignment mark regions 10B disposed along borders of the patterned retardation region 10A. Each alignment mark region 10B may have a single-straight-line pattern, for example, as shown in FIG. 1B. Alternatively, while not shown, the alignment mark region 10B may have a multiple-straight-line pattern, a dot-line pattern, a broken-line pattern, a dashed-line pattern, a dot pattern, a circle pattern, or a combination thereof.

The retardation film 10 includes, for example, a retardation layer 12 and a protective film 13 on a substrate 11 as shown in FIG. 2. An optical function layer 14 such as an anti-glare layer or an anti-reflection layer may be provided between the retardation layer 12 and the protective film 13 as shown in FIG. 3. When no layer is provided between the retardation layer 12 and the protective film 13, the protective film 13 is separably attached to the retardation layer 12. In contrast, when the optical function layer 14 is provided between the retardation layer 12 and the protective film 13, the protective film 13 is separably attached to the optical function layer 14.

The retardation layer 12 has a flat region (non-orientation region 12E) in which the patterned retardation region 10A and the alignment mark region 10B are not formed. For example, the flat region is formed between the patterned retardation region 10A and the alignment mark region 10B as shown in FIG. 1B.

The substrate 11 is a sheet-like film supporting the retardation layer 12, and is configured of, for example, a transparent resin film. For example, the substrate 11 is preferably small in optical anisotropy, namely, small in birefringence. A transparent resin film having such a property includes, for example, TAC (triacetylcellulose), COP (cycloolefin polymer), COC (cycloolefin copolymer), or PMMA (polymethylmethacrylate). COP includes, for example, ZEONOR or ZEONEX (registered trademark of ZEON CORPORATION) or ARTON (registered trademark of JSR Corporation). Thickness of the substrate 11 is, for example, 30 to 500 μm. For example, the substrate 11 may have a single-layer structure or a multi-layer structure. When the substrate 11 has a multi-layer structure, the substrate 11 has, for example, a two-layer structure including, while not shown, a resin layer formed on a surface of a base.

The retardation layer 12 has retardation regions 12A and 12B in the patterned retardation region 10A, and has a mark region 12C and mark surrounding regions 12D in the alignment mark region 10B. The retardation layer 12 further has, for example, a flat region (non-orientation region 12E) in which the patterned retardation region 10A and the alignment mark region 10B are not formed. The non-orientation region 12E is substantially free from retardation, and, for example, formed between the patterned retardation region 10A and the alignment mark region 10B as shown in FIG. 2. The non-orientation region 12E may be eliminated as necessary.

For example, the retardation regions 12A and 12B have a stripe pattern each, and are alternately arranged in the patterned retardation region 10A. For example, stripe width in each retardation region is the same as a pixel pitch of a display device. The retardation regions 12A and 12B have different retardation characteristics from each other. Specifically, the retardation region 12A has a slow axis AX1 in a predetermined direction, and the retardation region 12B has a slow axis AX2 in a direction different from the direction of the slow axis AX1. For example, the slow axes AX1 and AX2 are perpendicular to each other. For example, retardation of the retardation region 12A is −λ/4, and retardation of the retardation region 12B is +λ/4. The retardation regions 12A and 12B preferably have the same absolute value of retardation. In this specification, λ denotes, for example, a major wavelength (for example, 550 nm) of a light source 420 in a detector 400 described later.

Retardation may be measured by several kinds of ellipsometry, for example, the rotating analyzer method and the Senarmont Method. In the specification, a value obtained using the rotating analyzer method is shown as a retardation value. In the above, the different signs of retardation show that directions of the respective slow axes are different by 90 degrees from each other.

Retardation need not have a value specified in the specification for any of wavelengths (over the whole visible range). For example, retardation preferably has the value specified in the specification in a green range corresponding to λ of about 500 to 560 nm. This is because a human retina has high sensitivity to light in a green wavelength band, and besides, when retardation is appropriately adjusted in the green region, retardation may be relatively appropriately adjusted even in a blue or red region.

For example, the mark region 12C and the mark surrounding region 12D have a stripe pattern each. The mark region 12C is surrounded by the mark surrounding regions 12D along all or part of borders of the mark region 12C. For example, the mark region 12C is formed (in a gap) between a pair of mark surrounding regions 12D as shown in FIG. 2. For example, respective stripe widths in the mark region 12C and the mark surrounding region 12D are the same as respective stripe widths in the retardation regions 12A and 12B. The mark region 12C and the mark surrounding region 12D have different retardation characteristics from each other. Specifically, the mark region 12C has a slow axis AX3 in a predetermined direction, and the mark surrounding region 12D has a slow axis AX4 in a direction different from the direction of the slow axis AX3. For example, the slow axes AX3 and AX4 are perpendicular to each other.

For example, the slow axes AX3 and AX4 are in directions different from those of the slow axes AX1 and AX2 in the patterned retardation region 10A, respectively, as shown in FIG. 1B. For example, retardation of the mark region 12C is different from retardation of the retardation region 12A or 12B, and retardation of the mark surrounding region 12D is different from retardation of the retardation region 12A or 12B. Here, the mark region 12C and the mark surrounding region 12D preferably have the same absolute value of retardation.

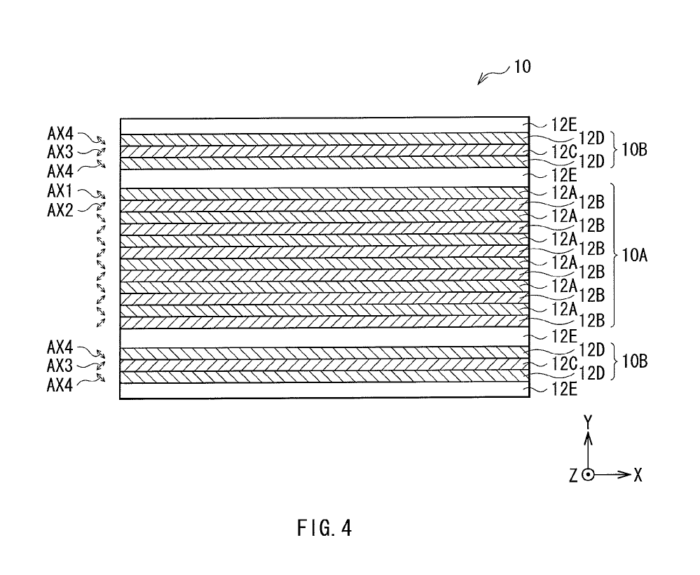

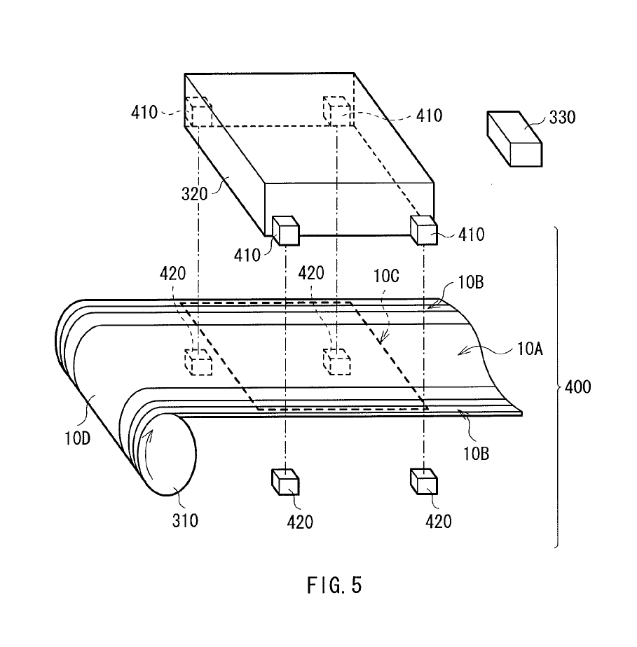

For example, the slow axes AX3 and AX4 may be in the same directions as those of the slow axes AX1 and AX2 in the patterned retardation region 10A, respectively, as shown in FIG. 4. For example, retardation of the mark region 12C is equal to retardation of the retardation region 12B (for example, +λ/4), and retardation of the mark surrounding region 12D is equal to retardation of the retardation region 12A (for example, −λ/4). Here, the mark region 12C and the mark surrounding region 12D preferably have the same absolute value of retardation.

The protective film 13, a transparent resin film, is separably attached to a surface of the retardation layer 12 (or the optical function layer 14) via an adhesion layer (not shown) or by static electricity. The protective film 13 has a retardation of (n/2−0.14)λ or more and (n/2+0.14)λ or less (n is an integer of 0 or more, and λ is the same as above).

Method of Manufacturing Retardation Film 10

Next, an example of a method of manufacturing the retardation film 10 is described. While a case that the retardation film 10 is manufactured using a roll sheet is described below, the retardation film 10 may be manufactured in a sheet-feeding manner.

First, while not shown, an optical orientation film, a rubbing orientation film, or a pattern-transfer orientation film is formed on a roll-sheet-like substrate including a thermoplastic material such as plastic. Here, portions of the optical orientation film, the rubbing orientation film, or the pattern-transfer orientation film are simultaneously collectively formed in correspondence to the retardation regions 12A and 12B, the mark region 12C, and the mark surrounding regions 12D, which are formed later. In this way, a roll-sheet-like substrate 11′ (not shown) is formed. The substrate 11′ refers to a windable roll sheet including the same layer structure and the same material as those of the substrate 11.

Next, a liquid crystal layer (not shown) containing a liquid-crystalline monomer is formed on a surface of the substrate 11′, followed by orientation treatment (heating treatment) of the liquid-crystalline monomer in the liquid crystal layer on the substrate 11′. Shearing stress may be produced at a boundary between the liquid-crystalline monomer and the substrate due to coating of the liquid-crystalline monomer in a previous step, causing orientation caused by flow (flow-induced orientation) or orientation caused by external force (external-force-induced orientation), and consequently liquid crystal molecules may be oriented in an unintentional direction. The heating treatment is performed to temporarily cancel an orientation state of the liquid-crystalline monomer oriented in such an unintentional direction. This allows solvent to be dried from the liquid crystal layer, and consequently only the liquid-crystalline monomer in a state of an isotropic phase is left in the liquid crystal layer.

Then, the liquid crystal layer is gradually cooled to a temperature slightly lower than the phase transition temperature of the monomer. The liquid crystal layer is cooled to a temperature lower than the phase transition temperature in this way, which allows the liquid-crystalline monomer to be oriented in accordance with respective patterns of the orientation film formed in the surface of the substrate 11′. After the orientation treatment, the liquid crystal layer is irradiated with UV light to polymerize the liquid-crystalline monomer. While such irradiation treatment is typically performed at approximately room temperature, the treatment temperature may be raised up to the phase transition temperature in order to adjust a retardation value. In addition, the liquid-crystalline monomer may be polymerized not only by UV light but also by heat or electron beams. However, use of UV light is advantageous in simplifying a process. Consequently, an orientation state of liquid crystal molecules is fixed, leading to formation of a retardation layer 12′ (not shown) including retardation regions 12A and 12B, mark regions 12C, and mark surrounding regions 12D. This is the end of manufacturing of a retardation roll sheet 10′ (not shown) having the retardation layer 12′ on the substrate 11′. The retardation layer 12′ refers to a layer in a shape of a windable roll sheet including the same layer structure and the same material as those of the retardation layer 12. Similarly, the retardation roll sheet 10′ refers to a windable roll sheet including the same layer structure and the same material as those of the retardation film 10.

Finally, the protective film 13 is attached to a surface of the retardation roll sheet 10′, and then the retardation roll sheet 10′ is wound on a winding roll (not shown). In this way, a retardation roll sheet 10D (not shown) having the protective film 13 on a surface thereof is manufactured.

Next, description is made on a method of manufacturing the retardation film 10 using the retardation roll sheet 10D manufactured by the above method. In the following, manufacturing equipment of the retardation film 10 is first described, and a manufacturing process of the retardation film 10 is then described.

FIG. 5 illustrates an example of a configuration of the manufacturing equipment of the retardation film 10. The manufacturing equipment includes an unwinding roll 310 that unwinds and supplies the retardation roll sheet 10D and a punching machine 320 that punches the retardation film 10 from the retardation roll sheet 10D. For example, the punching machine 320 includes a blade (not shown) for punching a portion (punched portion 10C) of the retardation roll sheet 10D just below the punching machine 320 and a support stage (not shown) for supporting the blade.

The manufacturing equipment further includes a stage (not shown) that adjusts a position of the punching machine 320, a processor 330 that controls a position of the stage and controls cameras 410 described later, and a detector 400 that detects a position of the punching machine 320 with respect to the retardation roll sheet 10D.

For example, in the case of detecting an optimum position of the punching machine 320, the stage allows the punching machine 320 to scan (move) in a direction perpendicular to an extending direction (moving direction) of the retardation roll sheet 10D according to a control signal from the processor. For example, in the case of alignment, the stage disposes the punching machine 320 at a desired position according to a control signal from the processor 330.

For example, in the case of detecting the optimum position, the processor 330 outputs the control signal to the stage to allow the punching machine 320 to scan, and concurrently outputs a control signal, to a plurality of (four) cameras 410 (described later) fixed to the punching machine 320, instructing the cameras to perform imaging. In the case of detecting the optimum position, the processor 330 acquires an image captured by the camera 410, and derives the optimum position of the punching machine 320 from the image. Furthermore, for example, in the case of punching, the processor 330 outputs a control signal to the stage to set the punching machine 320 to the optimum position, and then outputs a control signal to the stage to press the punching machine 320 to the retardation roll sheet 10D.

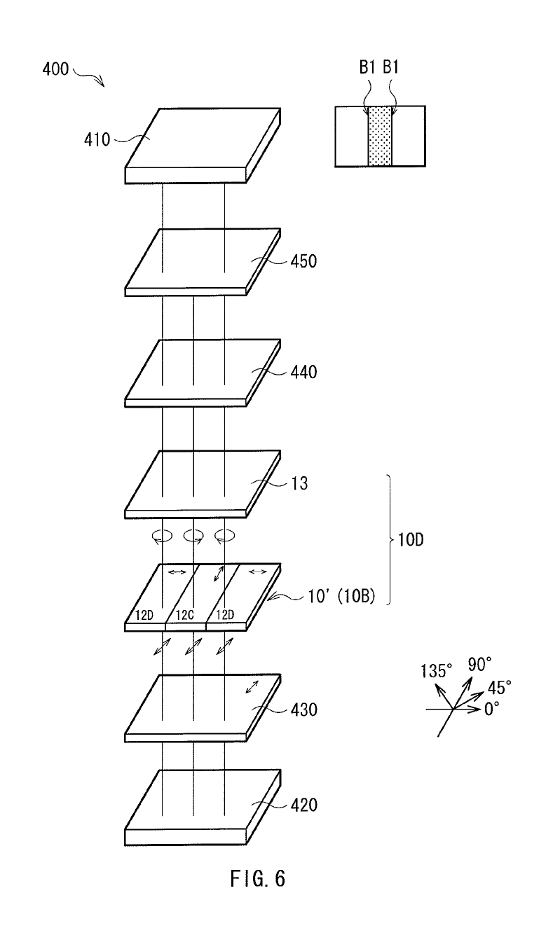

The detector 400 includes, for example, the plurality of (four) cameras 410 fixed to the punching machine 320 as shown in FIG. 5. The detector 400 includes, for example, a light source 420, a polarizing plate 430, a retardation film 440, and a polarizing plate 450 for each of the cameras 410, as shown in FIG. 6. The light source 420, the polarizing plate 430, the retardation film 440, and the polarizing plate 450 are disposed in at least an imaging area of the camera 410, and disposed in this order toward the punching machine 320.

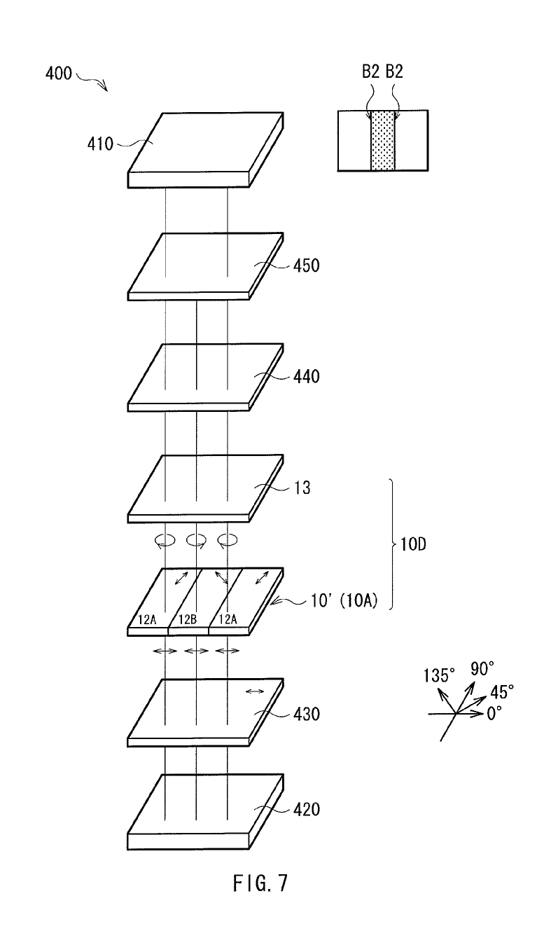

The retardation roll sheet 10D is disposed between the polarizing plate 430 and the retardation film 440 in such a manner that the protective film 13 faces the retardation film 440. For example, the light source 420 and the polarizing plate 430 are fixed just below the retardation roll sheet 10D, for example, just below an alignment mark region 10B of the retardation roll sheet 10D as shown in FIG. 6. For example, the light source 420 and the polarizing plate 430 may be fixed just below a patterned retardation region 10A of the retardation roll sheet 10D as shown in FIG. 7.

For example, the retardation film 440 and the polarizing plate 450 move together with the camera 410 and the punching machine 320 in the direction perpendicular to the extending direction (moving direction) of the retardation roll sheet 10D. For example, the retardation film 440 and the polarizing plate 450 are fixed on a lens (not shown) of the camera 410.

For example, the camera 410 is configured of a CMOS (Complementary Metal Oxide Semiconductor) image sensor or a CCD (Charge Coupled Device) image sensor. For example, the light source 420 outputs non-polarized white light. The polarizing plate 430 transmits a polarization component in a predetermined direction (for example, 45-degree direction). The retardation film 440 is configured of a (2n+1)λ/4 retardation film (n is an integer of 0 or more). The polarizing plate 450 transmits a polarization component in a predetermined direction (for example, 135-degree direction).

The manufacturing equipment having such a configuration is used to form the retardation film 10. Specifically, first, the retardation roll sheet 10D is unwound and supplied from the unwinding roll 310 and moves in the extending direction of the retardation roll sheet 10D. Concurrently, each camera 410 is allowed to scan in the direction perpendicular to the extending direction of the retardation roll sheet 10D. For example, when the light source 420 and the polarizing plate 430 are fixed just below the alignment mark region 10B of the retardation roll sheet 10D, an imaging area of each camera 410 traverses a region including the alignment mark region 10B of the retardation roll sheet 10D and borders of the patterned retardation region 10A of the sheet 10D. On the other hand, when the light source 420 and the polarizing plate 430 are fixed just below the patterned retardation region 10A of the retardation roll sheet 10D, an imaging area of each camera 410 traverses a region including borders of the patterned retardation region 10A of the sheet 10D.

When the light source 420 and the polarizing plate 430 are fixed just below the alignment mark region 10B of the retardation roll sheet 10D, each camera 410 may detect an image of the retardation roll sheet 10D, for example, an image as shown in upper right of FIG. 6. For example, the mark region 12C in the alignment mark region 10B is black, and the mark surrounding region 12D therein is white. Accordingly, (two) boundaries B1 between the mark region 12C and the mark surrounding regions 12D are detected from an image captured during scan of each camera 410 in the direction perpendicular to the extending direction of the retardation roll sheet 10D, and furthermore a relative positional relationship of each camera 410 to the alignment mark region 10B is derived from the image.

In contrast, when the light source 420 and the polarizing plate 430 are fixed just below the patterned retardation region 10A of the retardation roll sheet 10D, each camera 410 may detect an image of the retardation roll sheet 10D, for example, an image as shown in upper right of FIG. 7. For example, the retardation region 12B in the patterned retardation region 10A is black, and the retardation region 12A therein is white. Accordingly, (two) boundaries B2 between the retardation regions 12A and 12B are detected from an image captured during scan of each camera 410 in the direction perpendicular to the extending direction of the retardation roll sheet 10D, and furthermore a relative positional relationship of each camera 410 to the patterned retardation region 10A is derived from the image.

The optimum position of the punching machine 320 is derived from the positional relationship obtained in this way, and the punching machine 320 is disposed at the optimum position. Then, the punching machine 320 is pressed to the retardation roll sheet 10D to punch the sheet 10D. In this way, the retardation film 10 is formed of the retardation roll sheet 10D.

Effects

Next, advantages of the method of manufacturing the retardation film 10 are described in contrast to a method of manufacturing a retardation film according to a comparative example.

When the retardation film is manufactured of a roll base, in the case that the retardation film is cut into a desired size, a protective film is beforehand attached to a surface of the roll base to protect the surface from being damaged or stained.

A PET film having high retardation is typically used for a base of the protective film. Since polarization is therefore disturbed by the protective film, the detection camera hardly captures a clear image of the alignment mark, which has led to a disadvantage of reduction in accuracy of position detection of the alignment mark, resulting in reduction in alignment accuracy.

In contrast, in the embodiment, a film having a retardation of (n/2−0.14)λ or more and (n/2+0.14)λ or less is used as the protective film 13 for protecting the retardation layer 12. Furthermore, when the retardation film 10 is punched from the retardation roll sheet 10D in a manufacturing process, the retardation film 440 including the (2n+1)λ/4 retardation film and the polarizing plate 450 are disposed between the camera 410 and the retardation roll sheet 10D. This allows a sufficiently high contrast to be obtained when the retardation layer 12 is imaged by the camera 410 through the protective film 13.

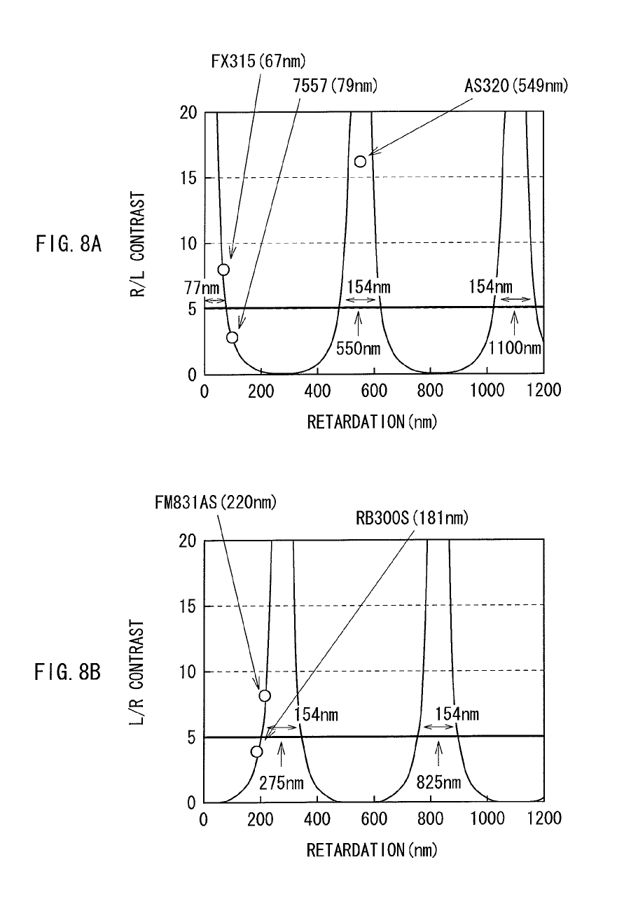

FIG. 8A illustrates a relationship between an R/L contrast (a ratio of luminance of the retardation region 12A to luminance of the retardation region 12B) and retardation of the protective film 13. FIG. 8B illustrates a relationship between an L/R contrast (a ratio of luminance of the retardation region 12B to luminance of the retardation region 12A) and retardation of the protective film 13. The R/L contrast means a degree of brightness of the retardation region 12A with respect to the retardation region 12B, and the L/R contrast means a degree of brightness of the retardation region 12B with respect to the retardation region 12A.

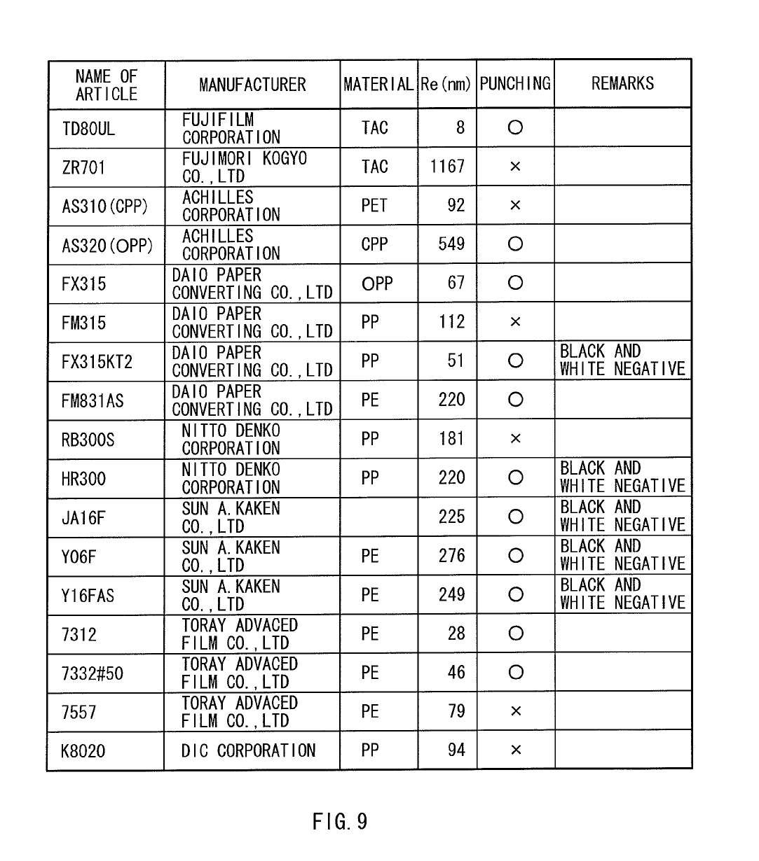

FIG. 9 illustrates a result of an experiment on punching accuracy when various commercially-available films are used as the protective film 13 in the manufacturing equipment of FIG. 5. A remark “black and white negative” in FIG. 9 means a black-and-white negative image of an image obtained by using another film. Results of five of the films in FIG. 9 are plotted in FIGS. 8A and 8B.

FIGS. 8A and 8B and FIG. 9 reveal that when retardation of the protective film 13 is (n/2−0.14)λ or more and (n/2+0.14)λ or less, both the R/L contrast and the L/R contrast are 5 or more. Moreover, FIGS. 8A and 8B and FIG. 9 reveal that when each contrast is 5 or more, the retardation film 10 may be accurately punched from the retardation roll sheet 10D. In other words, when each contrast is 5 or more, the boundaries B1 and B2 may be recognized from an image captured by the camera 410, and thus the retardation film 10 may be accurately punched from the retardation roll sheet 10D.

In this way, in the embodiment, when the retardation roll sheet 10D is imaged by the camera 410 through the protective film 13, a sufficiently high contrast may be obtained. As a result, alignment accuracy may be improved.

In the past, since the alignment mark is formed by printing or the like on a retardation film before punching, or a retardation region is formed in a film with the mark, the retardation region is formed in a separate step from formation of the alignment mark. It is therefore necessary to perform accurate positioning of one while recognizing a position of the other in order to improve alignment accuracy. This has disadvantageously resulted in a complicated manufacturing process or increase in number of steps.

On the other hand, in the embodiment, portions of the optical orientation film, the rubbing orientation film, or the pattern-transfer orientation film are simultaneously collectively formed in correspondence to the retardation regions 12A and 12B, the mark regions 12C, and the mark surrounding regions 12D on a roll-sheet-like substrate including a thermoplastic material such as plastic. This eliminates need of accurate positioning of the alignment mark region 10B while recognizing a position of the patterned retardation region 10A. As a result, alignment accuracy may be improved with a simple method and in a small number of steps.

### 2. Application Examples

### Application Example 1

For example, the detector 400 in the embodiment may be applied to attaching the retardation film 10 to a black stripe film 600 as shown in FIGS. 10, 11 and 12.

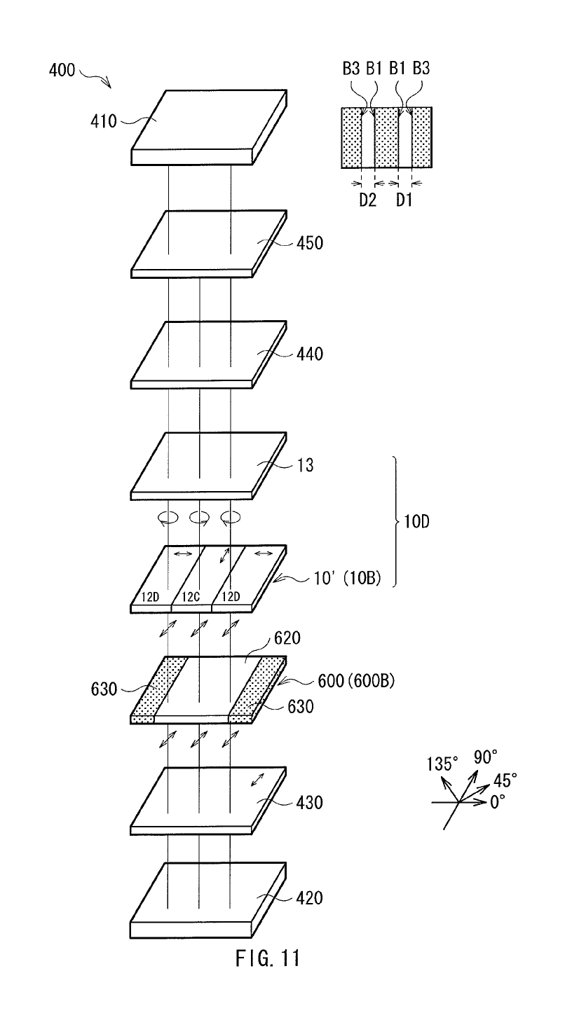

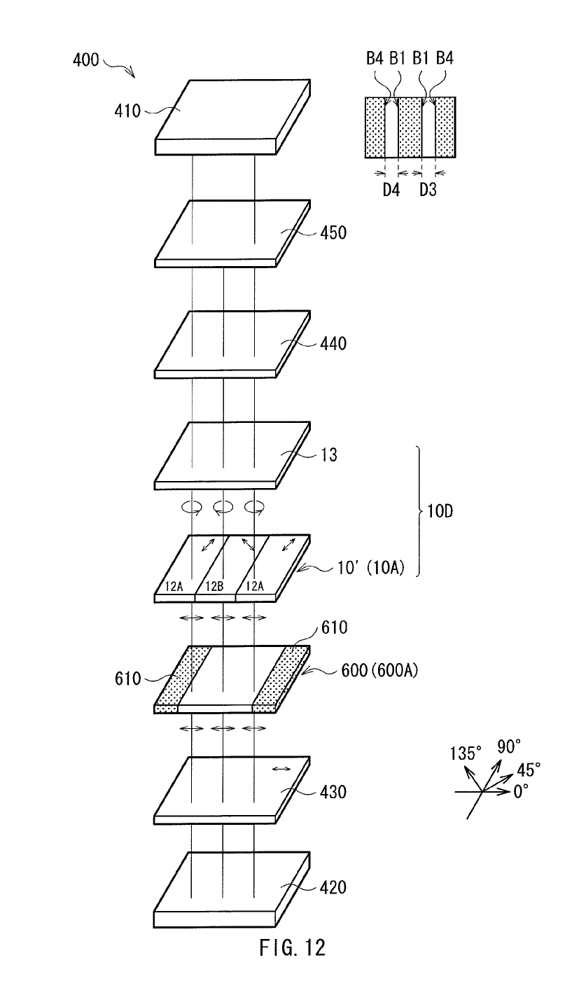

FIG. 10 schematically illustrates an aspect of attaching the retardation film 10 to the black stripe film 600. FIGS. 11 and 12 illustrate an example of a configuration necessary for using the detector 400 for attaching the retardation film 10 to the black stripe film 600.

The black stripe film 600 reduces crosstalk that may occur when the retardation film 10 is used for 3D display, and, for example, has a black stripe region 600A and alignment mark regions 600B as shown in FIG. 10. The black stripe region 600A is disposed at a position to be opposed to a display pixel region when the black stripe film 600 is used for 3D display.

The black stripe region 600A has black stripes 610 (see FIG. 12) in regions opposed to boundaries between the retardation regions 12A and 12B when the retardation film 10 is used for 3D display. The alignment mark region 600B has a mark surrounding region 620 having width wider than width of the mark region 12C of the retardation film and a pair of mark regions 630 provided on both sides of the mark surrounding region 620 (see FIG. 11). The black stripe 610 and the mark region 630 have light-blocking properties, and the mark surrounding region 620 and any region other than the black stripes 610 in the black stripe region 600A have light-transmitting properties. In the alignment mark region 600B, at least the mark surrounding region 620 is configured of a material substantially free from retardation.

The detector 400 having the above configuration is used to attach the retardation film 10 to the black stripe film 600. Specifically, first, the retardation film 10 and the black stripe film 600 are disposed at predetermined positions. Next, for example, each camera 410 is allowed to scan together with the retardation film 10 in a direction perpendicular to an extending direction of the alignment mark region 10B of the retardation film 10.

Next, for example, when the light source 420 and the polarizing plate 430 are fixed just below the alignment mark region 10B, an imaging area of each camera 410 traverses, for example, a region including the alignment mark region 10B and borders of the patterned retardation region 10A. On the other hand, when the light source 420 and the polarizing plate 430 are fixed just below the patterned retardation region 10A, an imaging area of each camera 410 traverses, for example, a region including borders of the patterned retardation region 10A.

When the light source 420 and the polarizing plate 430 are fixed just below the alignment mark region 10B, each camera 410 may detect an image of the retardation film 10, for example, an image as shown in upper right of FIG. 11. For example, the mark region 12C in the alignment mark region 10B is black, and the mark surrounding region 12D therein is white. Accordingly, (two) boundaries B1 between the mark region 12C and the mark surrounding regions 12D, (two) boundaries B3 between the mark regions 630 and the mark surrounding region 620, and distances D1 and D2 between the boundaries B1 and B3 are detected from an image captured during scan of each camera 410 in the direction perpendicular to the extending direction of the alignment mark region 10B (see an upper right figure of FIG. 11). Here, for example, a position of the retardation film 10, at which the distances D1 and D2 derived from the image captured by each camera 410 are equal or approximately equal to each other, is derived. The position obtained in this way is set as an optimum position of the retardation film 10, and the retardation film 10 is disposed at the derived optimum position. Then, the retardation film 10 is pressed to the black stripe film 600 so that the retardation film 10 is attached to the black stripe film 600. In this way, the retardation film 10 is attached to the black stripe film 600.

On the other hand, when the light source 420 and the polarizing plate 430 are fixed just below the patterned retardation region 10A, each camera 410 may detect an image of the retardation film 10, for example, an image as shown in upper right of FIG. 12. For example, the retardation region 12B in the patterned retardation region 10A is black, and the retardation region 12A therein is white. Accordingly, (two) boundaries B2 between the retardation regions 12A and 12B, (two) borders B4 of the black stripe 610, and distances D3 and D4 between the boundaries B2 and B4 are detected from an image captured during scan of each camera 410 in the direction perpendicular to the extending direction of the patterned retardation region 10A (see an upper right figure of FIG. 12). Here, for example, a position of the retardation film 10, at which the distances D3 and D4 derived from the image captured by each camera 410 are equal or approximately equal to each other, is derived. The position obtained in this way is set as an optimum position of the retardation film 10, and the retardation film 10 is disposed at the derived optimum position. Then, the retardation film 10 is pressed to the black stripe film 600 so that the retardation film 10 is attached to the black stripe film 600. In this way, the retardation film 10 is attached to the black stripe film 600.

In the application example, a film having a retardation of (n/2−0.14)λ or more and (n/2+0.14)λ or less is used as the protective film 13 for protecting the retardation layer 12 in the same way as the embodiment. Furthermore, when the retardation film 10 is attached to the black stripe film 600 in a manufacturing process, a retardation film 440 including a (2n+1)λ/4 retardation film and a polarizing plate 450 are disposed between the camera 410 and the retardation film 10. This allows a sufficiently high contrast to be obtained when the retardation layer 12 is imaged by the camera 410 through the protective film 13. As a result, alignment accuracy may be improved.

### Application Example 2

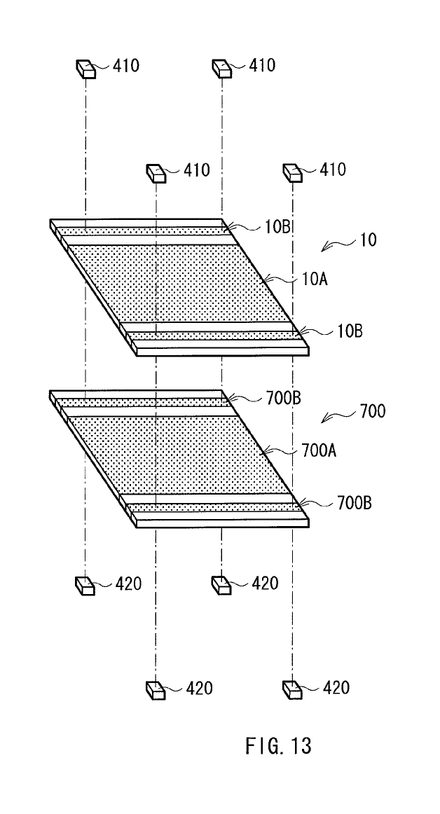

For example, the detector 400 in the embodiment may be further applied to attaching the retardation film 10 to a display panel 700 as shown in FIGS. 13, 14 and 15.

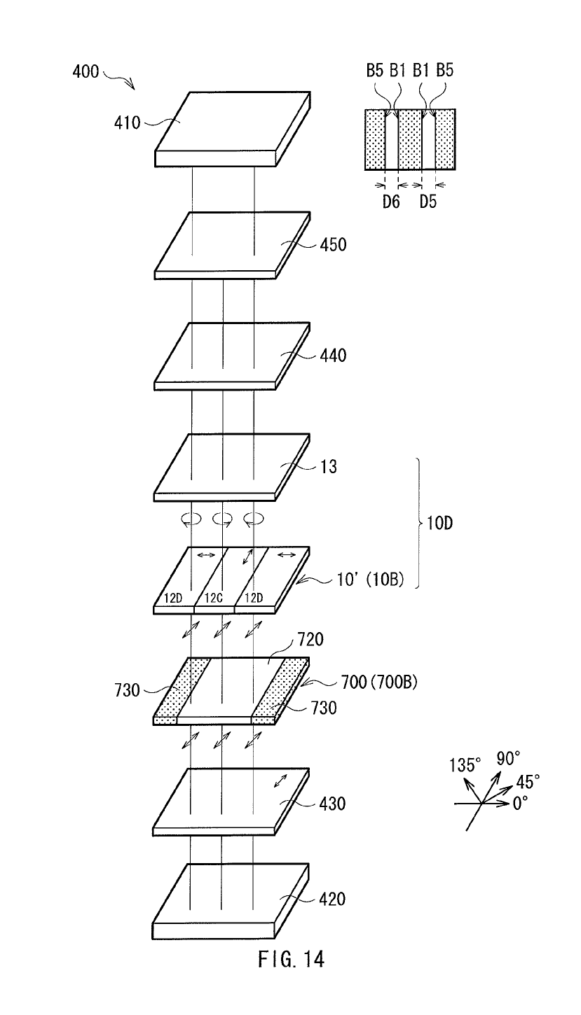

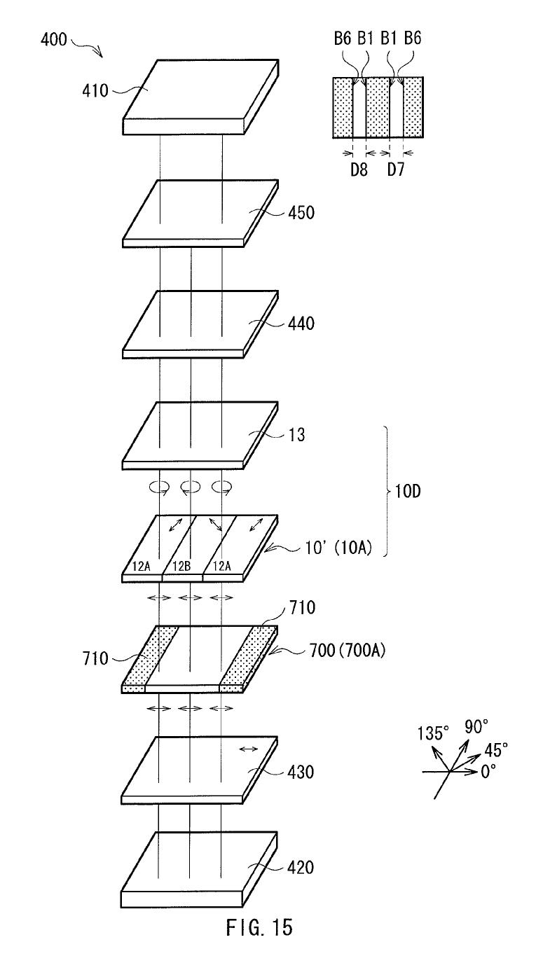

FIG. 13 schematically illustrates an aspect of attaching the retardation film 10 to the display panel 700. FIGS. 14 and 15 illustrate an example of a configuration necessary for using the detector 400 for attaching the retardation film 10 to the display panel 700.

While not shown, the display panel 700 includes, for example, a panel section and a deflector provided on a light emission side of the panel section. The panel section includes, for example, a liquid crystal panel, a plasma display panel, an organic EL display panel, and a cathode ray tube. The display panel 700 has, for example, a display pixel region 700A and alignment mark regions 700B as shown in FIG. 13. The display pixel region 700A is to output image light.

The display pixel region 700A has boundaries 710 (see FIG. 15) in regions opposed to boundaries between pixels adjacent to each other. The alignment mark region 700B has a mark surrounding region 720 having width wider than width of the mark region 12C of the retardation film and a pair of mark regions 730 provided on both sides of the mark surrounding region 720 (see FIG. 14). The boundary 710 and the mark region 730 have light-blocking properties, and the mark surrounding region 720 and any region other than the boundaries 710 in the display pixel region 700A have light-transmitting properties. In the alignment mark region 700B, at least the mark surrounding region 720 is configured of a material substantially free from retardation.

The detector 400 having the above configuration is used to attach the retardation film 10 to the display panel 700. Specifically, first, the retardation film 10 and the display panel 700 are disposed at predetermined positions. Next, for example, each camera 410 is allowed to scan together with the retardation film 10 in a direction perpendicular to the extending direction of the alignment mark region 10B of the retardation film 10.

Next, for example, when the light source 420 and the polarizing plate 430 are fixed just below the alignment mark region 10B, an imaging area of each camera 410 traverses, for example, a region including the alignment mark region 10B and borders of the patterned retardation region 10A. On the other hand, when the light source 420 and the polarizing plate 430 are fixed just below the patterned retardation region 10A, an imaging area of each camera 410 traverses, for example, a region including borders of the patterned retardation region 10A.

When the light source 420 and the polarizing plate 430 are fixed just below the alignment mark region 10B, each camera 410 may detect an image of the retardation film 10, for example, an image as shown in upper right of FIG. 14. For example, the mark region 12C in the alignment mark region 10B is black, and the mark surrounding region 12D therein is white. Accordingly, (two) boundaries B1 between the mark region 12C and the mark surrounding regions 12D, (two) boundaries B5 between the mark regions 730 and the mark surrounding region 720, and distances D5 and D6 between the boundaries B1 and B5 are detected from an image captured during scan of each camera 410 in the direction perpendicular to the extending direction of the alignment mark region 10B (see an upper right figure of FIG. 14). Here, for example, a position of the retardation film 10, at which the distances D5 and D6 derived from the image captured by each camera 410 are equal or approximately equal to each other, is derived. The position obtained in this way is set as an optimum position of the retardation film 10, and the retardation film 10 is disposed at the derived optimum position. Then, the retardation film 10 is pressed to the display panel 700 so that the retardation film 10 is attached to the display panel 700. In this way, the retardation film 10 is attached to the display panel 700.

On the other hand, when the light source 420 and the polarizing plate 430 are fixed just below the patterned retardation region 10A, each camera 410 may detect an image of the retardation film 10, for example, an image as shown in upper right of FIG. 15. For example, the retardation region 12B in the patterned retardation region 10A is black, and the retardation region 12A therein is white. Accordingly, (two) boundaries B2 between the retardation regions 12A and 12B, (two) borders B6 of the respective boundaries 710, and distances D7 and D8 between the boundaries B2 and the borders B6 are detected from an image captured during scan of each camera 410 in the direction perpendicular to the extending direction of the patterned retardation region 10A (see an upper right figure of FIG. 15). Here, for example, a position of the retardation film 10, at which the distances D7 and D8 derived from the image captured by each camera 410 are equal or approximately equal to each other, is derived. The position obtained in this way is set as an optimum position of the retardation film 10, and the retardation film 10 is disposed at the derived optimum position. Then, the retardation film 10 is pressed to the display panel 700 so that the retardation film 10 is attached to the display panel 700. In this way, the retardation film 10 is attached to the display panel 700.

In the application example, a film having a retardation of (n/2−0.14)λ or more and (n/2+0.14)λ or less is used as the protective film 13 for protecting the retardation layer 12 in the same way as the embodiment. Furthermore, when the retardation film 10 is attached to the display panel 700 in a manufacturing process, a retardation film 440 including a (2n+1)λ/4 retardation film and a polarizing plate 450 are disposed between the camera 410 and the retardation film 10. This allows a sufficiently high contrast to be obtained when the retardation layer 12 is imaged by the camera 410 through the protective film 13. As a result, alignment accuracy may be improved.

While the disclosure has been described with the embodiments and the application examples hereinbefore, the embodiments and the like are not limitative, and various modifications or alterations may be made.

For example, while the pair of mark surrounding regions 12D have been provided in the alignment mark region 10B in the embodiments and the like, one or both of the mark surrounding regions 12D may be omitted.

For example, while the plurality of cameras 410 have been used for the detector 400 in the embodiments and the like, only one camera 410 may be used.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A method of manufacturing a laminate comprising:
a first step of preparing equipment having one or more cameras and a processor processing an image captured by each of the cameras, and having a polarizing plate and a (2n+1)λ/4 retardation film (n is an integer of 0 or more, and λ denotes a wavelength) in this order from a side of the camera within an imaging area of the camera;
a second step of preparing a retardation film having a retardation layer with a patterned retardation region including two or more kinds of retardation regions different in slow-axis direction from each other and having a protective film with a retardation of (n/2−0.14)λ or more and (n/2+0.14)λ or less, and preparing an object to be attached with the retardation film;
a third step of deriving, by the processor, an in-plane positional relationship between the retardation film and the object from an image of each of the retardation film and the object captured by the camera while the retardation film and the object are disposed in this order from a side of the camera within the imaging area of the camera at positions on a side opposite to the camera with respect to the (2n+1)λ/4 retardation film; and
a fourth step of performing alignment of the retardation film to the object based on the positional relationship derived by the processor, and then attaching the retardation film to the object.

2. The method of manufacturing the laminate according to claim 1, wherein the object includes a display panel or a black stripe film.

3. The method of manufacturing the laminate according to claim 1, wherein the in-plane positional relationship between the retardation film and the object is derived by the processor by using a contrast in the patterned retardation region and a contrast of a particular region in the object in the third step.

4. The method of manufacturing the laminate according to claim 1,
wherein the retardation layer has alignment mark regions disposed along borders of the patterned retardation region, each alignment mark region including a mark region and a mark surrounding region having different slow-axis directions from each other, and
the in-plane positional relationship between the retardation film and the object is derived by the processor by using a contrast in the alignment mark region and a contrast of a particular region in the object in the third step.

5. A method of manufacturing a retardation film comprising:
a first step of preparing equipment having a punching machine, one or more cameras fixed to the punching machine, and a processor processing an image captured by each of the cameras, and having a polarizing plate and a (2n+1)λ/4 retardation film (n is an integer of 0 or more, and λ denotes a wavelength) in this order from a side of the camera within an imaging area of the camera;
a second step of preparing a retardation roll sheet having a retardation layer with a patterned retardation region including two or more kinds of retardation regions different in slow-axis direction from each other and having a protective film with a retardation of (n/2−0.14)λ or more and (n/2+0.14)λ or less;
a third step of deriving, by the processor, an in-plane positional relationship between the retardation roll sheet and the punching machine from an image of the retardation roll sheet captured by the camera; and
a fourth step of performing alignment of the retardation roll sheet to the punching machine based on the positional relationship derived by the processor, and then producing a retardation film by punching the retardation roll sheet by the punching machine.

6. The method of manufacturing the retardation film according to claim 5,
wherein the in-plane positional relationship between the retardation roll sheet and the punching machine is derived by the processor by using a contrast in the patterned retardation region in the third step.

7. The method of manufacturing the retardation film according to claim 5,
wherein the retardation layer has alignment mark regions disposed along borders of the patterned retardation region, each alignment mark region including a mark region and a mark surrounding region different in slow-axis direction from each other, and
the in-plane positional relationship between the retardation roll sheet and the punching machine is derived by the processor by using a contrast in the alignment mark region in the third step.

8. A retardation film comprising:
a retardation layer; and
a protective film,
wherein the retardation layer has a patterned retardation region including two or more kinds of retardation regions different in slow-axis direction from each other, and
the protective film has a retardation of (n/2−0.14)λ or more and (n/2+0.14)λ or less (n is an integer of 0 or more, and λ denotes a wavelength).

9. The retardation film according to claim 8, wherein the retardation layer has alignment mark regions disposed along borders of the patterned retardation region, each alignment mark region including a mark region and a mark surrounding region different in slow-axis direction from each other.

10. The retardation film according to claim 8, wherein the retardation film has a roll-like or sheet-like film supporting the retardation layer.

11. The retardation film according to claim 8, wherein the protective film is separably attached to the retardation layer.

12. The retardation film according to claim 8,
wherein an anti-glare layer or an anti-reflection layer is provided between the retardation layer and the protective film, and
the protective film is separably attached to the anti-glare layer or the anti-reflection layer.
